(19) United States
(12) Patent Application Publication
(10) Pub. No.: US 2006/0200053 A1
(43) Pub. Date: Sep. 7, 2006

(54) Body massaging device

(76) Inventor: Dwayne Lacey, White Gum Valley (AU)

Correspondence Address: BURR & BROWN, PO BOX 7068, SYRACUSE, NY, 13261-7068, US

(21) Appl. No.: 11/081,231

(22) Filed: Mar. 16, 2005

(30) Foreign Application Priority Data
Mar. 3, 2005 (AU) 2005901001

(51) Int. Cl. A61H 1/00

(52) U.S. Cl. 601/72; 601/136; 601/46

(57) ABSTRACT

A body massaging device 10 comprises a handle 12, at least one massaging element 14, and a coupling member 16 releasably engagable with the handle 12. The member 16 is provided with at least one passage 18 for releasably engaging or receiving a portion of a massaging element 14. Each massaging element has a massaging end 15 distant the handle 12. The massaging elements 14 are retained in the passages 18 between the handle 12 and the insert 16.

### FIELD OF THE INVENTION

The present invention relates to a body massaging device.

### BACKGROUND OF THE INVENTION

Massage is used for many different purposes including for medical treatment; relief of stress and tension; and providing physical relaxation, stimulation and pleasure. Massaging can be performed by direct hand/finger manipulation or through the use of massaging tools and devices. These tools may be broadly categorized into hand-held tools and other tools. The other tools may include, for example, vibrating chairs and beds, belts or bands that may be strapped or applied about the body which provide mechanical or electrical stimulation. The present invention relates more specifically to hand-held massaging tools and devices.

Many different types of hand-held massaging devices are readily available. These include for example “spiders” made typically from wood or rigid plastics materials comprising a central sphere or body portion that acts as a handle and a plurality of spheres or rounded elements attached to the body by rigid links that can be applied to a person's body. Other hand-held tools are known which comprise a plurality of scalloped or shaped wheels that can be run along the human body.

### SUMMARY OF THE INVENTION

According to the present invention there is provided a body massaging device comprising:
a handle;
at least one massaging element having a massaging end that extends from the handle; and,
a coupling member releasably engagable with the handle;
   one of the handle and the coupling member being provided with at least one passage that releasably engages a portion of a respective massaging element, the respective massaging element being retained between the handle and the coupling member.

In an embodiment where the at least one passage is formed in the coupling member, the passages may take several different configurations. For example each passage may extend wholly along an outer surface of the coupling member. In an alternative configuration each passage may extend wholly through the coupling member. In yet a further variation each passage may extend partially along an outer surface of the coupling member and open onto an end of the coupling member that faces away from the handle.

In an embodiment where each passage is formed in the handle, the handle may be provided with a cavity that receives the coupling member, the cavity having a side wall in which each passage is formed, the side wall having an outer end leading to an outer surface of the handle, and an inner end disposed inside of the handle.

In this embodiment, each passage may extend between and open onto both the outer end and the inner end of the side wall. However in an alternative embodiment, one end of each passage opens onto the outer end of the side wall and terminate inboard of the inner end of the side wall. In yet a further variation, each passage has opposite first and second ends both of which open onto the outer end of the side wall.

In an alternate embodiment the passage may comprise a first length that penetrates wholly through the insert and extends inwardly from an outer circumferential surface of the insert and a second length recessed into a face of the insert innermost in the cavity. In this embodiment the massaging element may comprise a first portion that extends through the first length and second portion that is seated on received in the second length.

In one embodiment the handle further comprises a clamping surface inside of the cavity, wherein each massaging element is clamped between the coupling element and the clamping surface.

In one form, each massaging element may comprise a single length of material that is bent to a configuration comprising two free ends located at the massaging end of the massaging element with a bend intermediate the two free ends. In this embodiment, when the end passages are formed either wholly along the outer surface of the coupling member or wholly through the coupling member, the massaging element is received by two of the passages with the bend extending between those two passages. However when the passage formed in the side of the cavity and the passage has two ends opening onto the outer end of the side wall, the bend is seated in the passage.

In an alternative embodiment each massaging element may comprise a single length of material comprising a single free end at the massaging end and an opposite second end at an end of the massaging element distant the first free end, wherein the second end is provided with a stop dimensioned to prevent entry into the passage. In this embodiment the stop is clamped between the coupling member and the clamping surface.

Optionally, the massaging device further comprises a vibrator disposed in the handle.

### BRIEF DESCRIPTION OF THE DRAWINGS

Embodiments of the present invention will now be described by way of example only with reference to the accompanying drawings in which:

FIG. 1 is a schematic representation of a first embodiment of the body massaging device;

FIG. 2 is an exploded view of the body massaging device depicted in FIG. 1;

FIG. 3 depicts a sub-assembly of the body massaging device shown in FIGS. 1 and 2;

FIG. 4 depicts a sub-assembly of an alternative embodiment of the body massaging device;

FIG. 5 depicts one possible arrangement of passages formed in the body massaging device;

FIG. 6 depicts an alternative form of passages formed in the body massaging device;

FIG. 7 depicts a further form of passages formed in the body massaging device;

FIG. 8 is a schematic representation of a further embodiment of the body massaging device;

FIG. 9 is a representation of a handle portion of a further embodiment of the body massaging device;

FIG. 10 is a representation of an insert and massaging element incorporated in a further embodiment of the body massaging device; and,

FIG. 11 is a rear plan view of the insert depicted in FIG. 10.

### DETAILED DESCRIPTION OF PREFERRED EMBODIMENTS

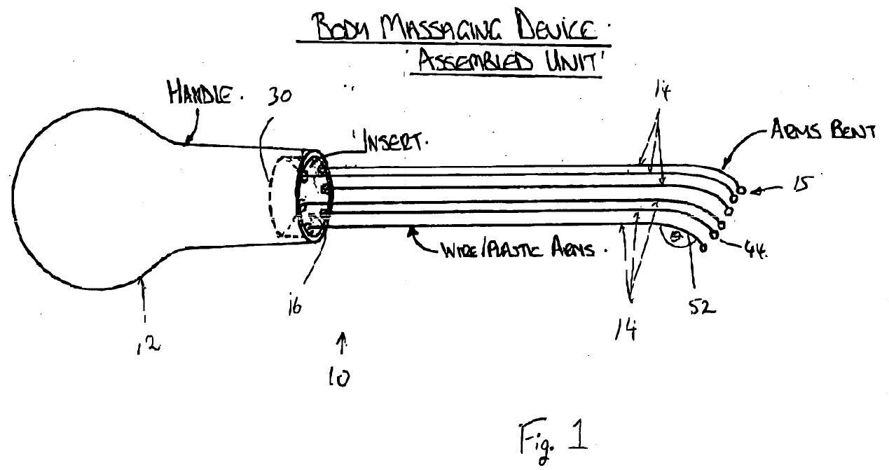

With reference to the accompanying drawings, and in particular FIGS. 1-3, an embodiment of the body massaging device 10 comprises a handle 12, at least one (and in this embodiment six) massaging elements 14, and a coupling member in the form of an insert 16 releasably engagable with the handle 12. The insert 16 is provided with at least one passage 18 for releasably engaging or receiving a portion of a massaging element 14. Each massaging element has a massaging end 15 distant the handle 12. The massaging elements 14 are retained in the passages 18 between the handle 12 and the insert 16.

The handle 12 has a bulbous portion 20 that is drawn down at one end to form a substantially cylindrical shank 22. An end 24 of the shank 22 distant the bulbous portion 20 is provided with a cavity 26 for receiving the insert 16. The cavity has a circumferential side wall 28 provided with a screw thread and is closed at an end inside of the end 24 by an end wall 30. It is envisaged that the structure of the side wall 28 and end wall 30 may be formed as a separate entity to the handle 12 and glued, press fit or otherwise permanently attached in a bore formed in the end 24 of the handle. In such a construction, the side wall 28 and end wall 30 would take the general form of a screw cap having a general configuration similar to that of a conventional soft drink bottle.

The insert 16 is in the form of a circular disc having first and second opposite planar axial ends surfaces 36 and 38 and a circumferential surface 40. The circumferential surface 40 is provided with a screw thread 42 for threadingly engaging the thread formed on the side wall 28 in the cavity 26. The passages 18 extend between and open onto the opposite end surfaces 36 and 38.

In this embodiment, the massaging elements 14 take the form of respective single lengths of material that are bent or otherwise formed into a configuration comprising two free ends 44 at the massaging end 15 with a intermediate bend 46. The free ends 44 are smoothly terminated in a bulb or ball structure 48. Advantageously, the elements 14 are made from wire such as copper wire. In the assembly of the massaging device 10, the massaging elements 14 are hooked onto the insert 16 so that a portion of the elements 14 adjacent the bend 46 is seated in adjacent passages 18 with the hook 46 adjacent the surface 38 of the insert 18. Alternatively, portions of each element may be seated in diametrically opposed passages.

With all of the elements 14 hooked or engaged with the insert 16 in a like manner, the insert is then screwed into the cavity 26 with its end surface 38 innermost. To assist in this process, the surface 36 of the insert may be provided with a recess 50 to receive the blade of a screwdriver. The insert 16 is screwed into the cavity 26 until the bends 46 abut the internal wall 30. In this way the massaging elements 14 are retained by the handle 14 and effectively clamped between the insert 16 and the wall 30.

As depicted in FIG. 1, the massaging elements 14 may be provided with a bend 52 near the free ends 44. The bends 52 are ideally radiused and having an included angle θ in a range of 90° to about 145°.

Construction of the device 10 in the manner described above allows easy changing if desired of the massaging elements 14 with elements of different lengths, resilience, configuration and number. For example, as shown much clearly in FIGS. 1 and 3, the free ends 44 of the elements 14 lie substantially along the same line. However the elements 14 can be configured so that one free end 44 is longitudinally offset from the other free end 44. Also, by using an insert 16 having a greater number of passages 18, more massaging elements 14 can be incorporated into the massaging device 10.

FIG. 4 depicts one variation in which the massaging elements 14 have a single free end 44a at the massaging end 15 and a second end 44b at an opposite end of the element 14. Both ends 44a and 44b are terminated in ball-like structures. End 44b is located adjacent the surface 38 of the insert 16 and its corresponding ball-like structure 48b acts as a stop, being dimensioned to prevent it passing through the passage 18.

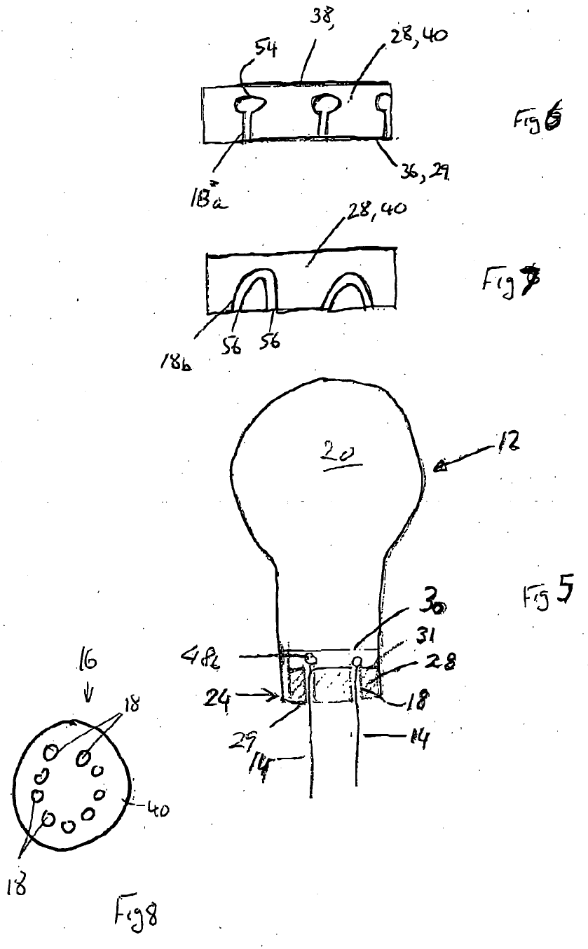

In the above described embodiments, the passages 18 are depicted and described as being located on the insert 16. However they may equally be provided on the side wall 28 of the cavity 26. This is shown in FIG. 5 where the passages 18 extend axially along the side wall 28 and open onto an outer end 29 and inner end 31 of the cavity 26. The inner end 31 is forward of the end wall 30 so that the insert 16 when screwed into the cavity 26 can collect balls 48b and clamp them against the wall 30. In addition, different configurations of passages 18 are possible.

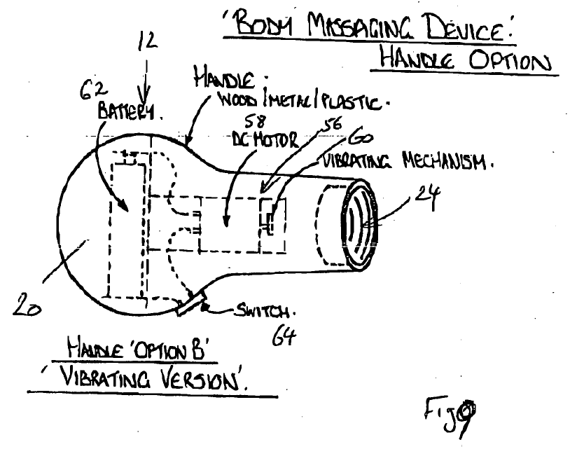

FIGS. 6 and 7 depict two possible variations of configuration of the passages 18 that can be applied to either the surface 40 of the insert 16 or the side wall 28.

In FIG. 6, each passage 18a opens at one end onto (a) the surface 36 formed on the insert 16; or (b) an outer edge 29 of the cavity 16 if the passage 18 is formed on the side wall 28. The passage 18a terminates at an opposite end inboard of the opposite surface 38 of insert 16 or inner end 31 of cavity 26 as the case may be, and is provided with a transverse portion 54 for receiving a complementarily-shaped end of a massaging element 14.

FIG. 7 depicts a further possible configuration of the passage 18b where the passage forms a loop opening at two different locations 56 onto the surface 36 (if in the insert 16) or outer end 29 (if in the side wall 28).

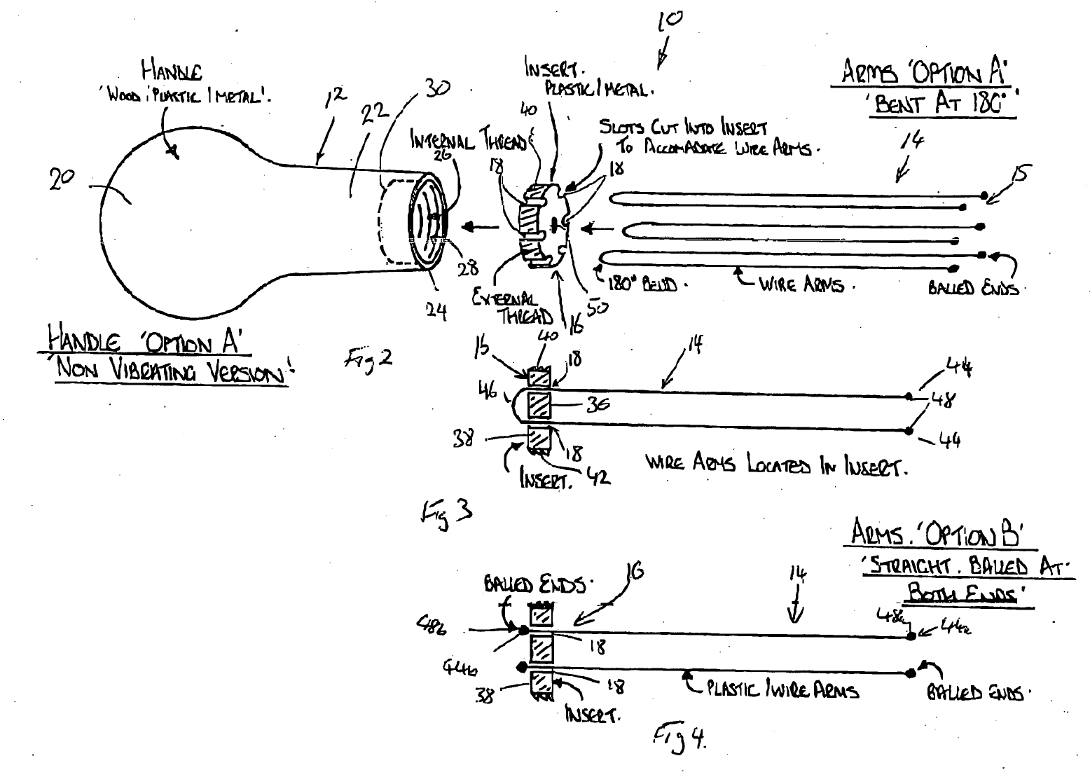

In yet a further embodiment depicted in FIG. 8 the passages 18c are formed wholly through the insert 16 inboard of the circumferential surface 40. In this embodiment, the massaging elements 14 are of the form shown in FIGS. 2 and 3 the passages 18 are formed of a size to allow the passage of the balls 48 with the bend 46 hooked between two adjacent passages 18 on the side 38 of the insert 16. However this embodiment is also usable with massaging elements of a single length of the type shown in FIG. 4 provided that end 44b comprises a stop dimensioned to prevent passage through the passage 18.

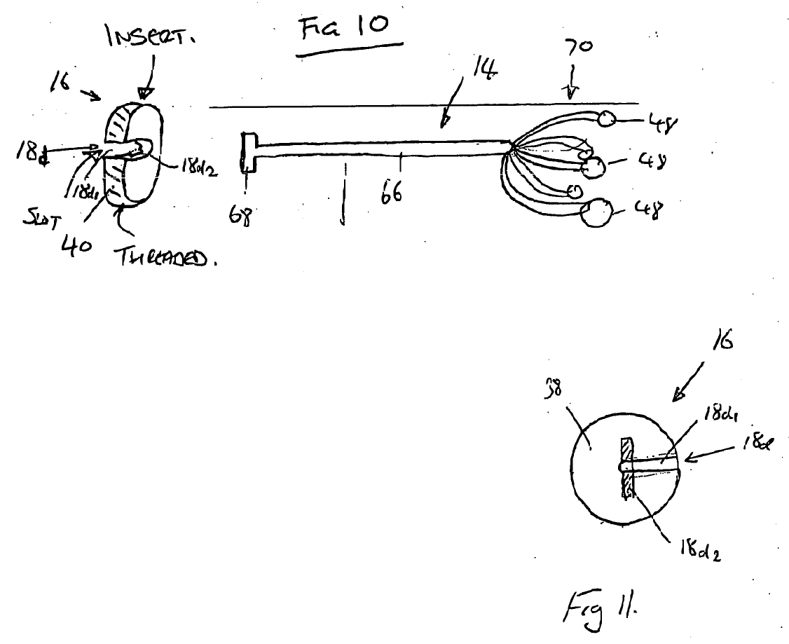

FIG. 9 depicts a modified handle 12 usable with a different embodiment of the massaging device 10. Here, the handle 20 is provided with an internal vibrator 56 comprising a DC motor 58 driving an eccentric weight 60. The motor 58 is powered by a battery 62 housed within the handle 20. A switch 64 is provided on an outer surface of the handle 12 to enable the turning ON and OFF of the vibrator 56.

The bulbous portion 20 of the handle may itself be used as a massaging portion of the device 10 by applying it directly to a person's body.

FIGS. 10 and 11 depict an insert 16 and massaging element 14 for an alternate embodiment of the body massaging device 10. In this embodiment, the insert is in the form of a disc as per the earlier embodiments but the slot 18d comprises two lengths, a first length 18d¹ that extends through the thickness of the insert 16 radially from the outer circumferential surface 40 to a center of the insert and a second length 18d² which extends transversely on opposite sides of the length 18d¹ near the centre of the insert 16. The second length 18d² is recessed into the surface 38 of the insert 16 but does not extends wholly through the thickness of the insert.

The massaging element 14 in this embodiment is in the form of a single or unitary attachment that is coupled to the device 10 by the insert 16. To this end, the attachment comprises an elongate shank 66 having a short cross bar 68 at one end and a plurality of massaging fingers 70 at an opposite end. The massaging fingers 70 each terminate in balls 48. The attachment is coupled to the handle 10 by aligning the cross bar 68 with the first length 18d¹ of the passage 18d then maneuvering the attachment so that the shank 66 is adjacent an inner most end of the length 18d and then turning the attachment 90° to seat the cross bar 68 in the second length 18d² of the passage. Thereafter, the insert 16 is screwed all the way in to the cavity 26. The locating of the cross bar 68 into the second length 18d² can be performed either with the insert 16 wholly removed from the cavity 26 or with the insert 16 partially screwed into the cavity 26.

This variation facilitates the provision of multiple attachments of different configuration that can be easily coupled and decoupled from the handle 12. For example, an attachment could take the form of the arrangement of fingers in Applicant's U.S. Pat. No. 6,309,365, the contents of which is incorporated herein by way of reference.

Now that embodiments of the present invention have been described in detail it will be apparent to those skilled in the relevant arts that numerous modifications and variations may be made without departing from the basic inventive concepts. For example, the insert 16 is described as being threadingly engagable in the cavity 26 of the handle 12. However different types of coupling arrangements can be used. For example, a snap-fit or bayonet mount can be used instead of the threaded coupling. Also, grommets of a resilient material may be inserted into the passages 18 to frictionally grip the portions of the massaging elements 14 received within the passages 18. Further, the balls 44b at the ends 48b of the massaging elements 14 show in FIGS. 4 and 7 can be deleted and the ends 48b simply bent say at right angles in order to hook over the insert 16.

All such modifications and variations together with others that would be obvious to a person of ordinary skill in the art are deemed to be within the scope of the present invention the nature of which is to be determined from the above description.

The claims defining the invention are as follows:

1. A body massaging device comprising:
a handle;
at least one massaging element having a massaging end that extends from the handle; and,
a coupling member releasably engagable with the handle, one of the handle and the coupling member being provided with at least one passage that releasably engages a portion of a respective massaging element, the respective massaging element being retained between the handle and the coupling member.

2. The body massaging device according to claim 1, wherein the at least one passage is formed in the coupling member.

3. The body massaging device according to claim 2, wherein the passages extend wholly along an outer surface of the coupling member.

4. The body massaging device according to claim 2, wherein the passages extend wholly through the coupling member.

5. The body massaging device according to claim 2, wherein the passages extend partially along an outer surface of the coupling member and open onto an end of the coupling member that faces away from the handle.

6. The body massaging device according to claim 1, wherein each passage is formed in the handle, and the handle is provided with a cavity that receives the coupling member, the cavity having a side wall in which each passage is formed, the side wall having an outer end leading to an outer surface of the handle, and an inner end disposed inside of the handle.

7. The body massing device according to claim 6, wherein each passage extends between and opens onto both the outer end and the inner end of the side wall.

8. The body massing device according to claim 6, wherein one end of each passage opens onto the outer end of the side wall and terminates inboard of the inner end of the side wall.

9. The body massaging device according to claim 6, wherein each passage has opposite first and second ends both of which open onto the outer end of the side wall.

10. The body massing device according to claim 2, wherein each passage comprises a first length that penetrates wholly through the coupling member and extends inwardly from an outer circumferential surface of the coupling member and a second length recessed into a face of the coupling member innermost in the cavity.

11. The body massaging device according to claim 10, wherein the massaging element comprises a first portion that extends through the first length and second portion that is seated on and received in the second length.

12. The body massing device according to claim 1, wherein the handle further comprises a clamping surface inside of the cavity, wherein each massaging element is clamped between the coupling element and the clamping surface.

13. The body massaging device according to claim 1, wherein each massaging element comprises a single length of material that is bent to a configuration comprising two free ends located at the massaging end of the massaging element with a bend intermediate the two free ends.

14. The body massaging device according to claim 1, wherein each massaging element comprises a single length of material comprising a single free end at the massaging end and an opposite second end at an end of the massaging element distant the first free end, wherein the second end is provided with a stop dimensioned to prevent entry into the passage.

15. The body massaging device according to claim 1, further comprising a vibrator disposed in the handle.
